(19) United States
(12) Patent Application Publication
(10) Pub. No.: US 2009/0253093 A1
(43) Pub. Date: Oct. 8, 2009

(54) Orthodontic Torque Pliers

(76) Inventor: Mazin M. Albaya, Baghdad (IQ)

Correspondence Address: Thomas E Sisson;Jackson Walker, 112 E. Pecan St, Suite 2400, San Antonio, TX, 78205, US

(21) Appl. No.: 12/227,917

(22) PCT Filed: Jun. 6, 2007
(86) PCT No.: PCT/CA2007/000994

§ 371 Date: Dec. 2, 2008

(30) Foreign Application Priority Data
Jun. 6, 2006 (CA) 2549635

(51) Int. Cl. A61C 3/00

(52) U.S. Cl. 433/4; 433/215

(57) ABSTRACT

The invention pertains to a tool or pliers for effecting a torque bends or twists to orthodontic rectangular arch wire. The pliers have two handles pivotally associated by a core, the core having a slot therein. One of the handles has a bifurcated head with the other handle having a single head adapted to fit within said bifurcated head and pivot on the core. The bifurcated headed handle has at least one slide reciprocally associated with a side of the bifurcated headed handle, the slide having a slot in an end thereof, the slide being manipulated so that its slot into aligned association with the slot in the core. The core is detachably secured to the single headed handle. Slots are in the single and bifurcated headed handles to access their bores so that all the slots can be aligned to accept an arch wire being passed through the slots in the handles and into the slots of the core and slide. Squeezing of the handles causes relative rotation between the core and slide to impart a twist to the wire. The degree of twist can be adjustably controlled. Preferably, there are two slides, one in each side of the bifurcated headed handle.

### FIELD OF THE INVENTION

The invention relates to orthodontic torque pliers and more particularly to pliers that enable an Orthodontist to effect torque bends or twists in arch wire in a calibrated specific and smooth manner without distortion to other parts of the arch wire.

### BACKGROUNDS OF THE INVENTION

An important challenge that faces Orthodontists is how best to apply a third arch bend (torque) or twist in the exact position and with exact angulation. Often the desired torque cannot be performed completely without affecting other parts of the arch wire that may result when in use in undesired teeth movement.

This is particularly so if the Orthodontist attempts to effect the torque twists or bends with two or a pair of pliers, the pliers gripping the arch wire on either side of the desired location for the twist or bend. The hands and arms effect relative rotation of the pliers and the axis of rotation of the pliers is the wire itself. Due to the nature of the wire and the lack of rigidity to resist lateral dislodging forces that may accompany the relative rotation of the pliers, the result is not solely a torque twist, but most often a combination rotation and displacement movement. It is very difficult using two pliers to effect only a torque twist or bend without distortion of other parts of the wire.

The U.S. patent to Sosnay U.S. Pat. No. 4,184,259 granted Jan. 22, 1980 discloses an orthodontic tool for placing bends or twists in orthodontic arch wires in order to place torquing forces in the wire. The tool includes indicator means to indicate the amount of twist or torque developed by the engaging means. The two engaging means are placed together and twisted around the arch wire with the indicator means, a pointer, indicating the amount of twist. The engaging means may comprise pliers and keyed members.

The U.S. patent to Rose, U.S. Pat. No. 4,043,364 granted Aug. 27, 1997 discloses a wire bending plier set for permanently twisting a portion of orthodontic wire about the wire axis to enable application of a torque force to a malpositioned tooth. The plier is configured to grip the wire at spaced apart positions between which the twisting bend is to be made. A lever or key is then engaged with the wire between the gripped areas and the lever or key rotated about the wire axis to stress the wire and impart the desired twist.

It would be desirable to provide a single tool or pliers which can be used to provide multi-torque bends in a single arch wire, each one specific to a single tooth and this can be accomplished in a single visit, which reduces chair time and treatment time.

The elasticity of arch wire varies according to size and material used and it would be advantageous to have a single tool or pliers wherein the amount of real torque can be determined as well as the amount of torque that may be lost because of the elasticity of the wire. It would also be advantageous to provide pliers which can be controlled by one hand while the other hand supports the arch wire upon the pliers.

It would also be advantageous to have a single tool or pliers which can be assembled and dismantled with ease.

### SUMMARY OF THE INVENTION

The invention pertains to a single tool or pliers for effecting a torque twist to orthodontic arch wire.

The invention assists Orthodontists in the application of torque (third order bends) in exact position and exact angulation, and apply a torque bend without detrimentally affecting other parts of the arch wire.

The pliers have a solid axis of rotation provided by a solid hinge upon which the handles of the pliers rotate. The solid hinge of the pliers permits the pliers to exert torque bends on a rectangular arch wire without affecting the ends of the wire on either side of the torque area. Multiple torque bends can be made on the single arch wire during a single visit of the patient and thereby reduces chair time. The pliers will also reduce the need to use pretorqued wires which are often more expensive.

Further, the torque inclination, twist, or bend angle can be determined with precision with the use of the calibrated scale or ruler fixed to one handle of the pliers in co-operation with a pointer on the other handle of the pliers. The ability to determine with precision the bend angle will assist in reducing the risk of excessive force applied to a single tooth or group of teeth when installed and can enhance the aesthetics and appearance of the work.

Further still, the pliers of the invention allow for standardization and repeatability of the torque applied to the arch wire, sometimes referred to in the profession as a “closing reference point” or “closing limit point”. An operator of the pliers can adjust a screw which permits adjustment to various degrees of angles and thereafter lock the screw, thereby enabling the operator to repeat the desired torque bend as often as required. This results in enabling the same degree of torque bend to be exerted to identical teeth in opposite arch wire halves, for example, upper left and right laterals or upper left and right premolars when a double torque technique is used. Single torque applications are applied at the beginning and at the end of the segment, and the pliers permit symmetry of the bends to reduce the possibility of differences in the torque angles.

As noted, the pliers permit both single torque, as well as double torque bends, a single torque being applied to a group of teeth and involves using one of the supporting slides whereas the double torque bend uses both support slides. In either case, both are obtained in essentially one step.

Further still, the pliers permit the arch wire to rotate around itself, i.e., around an imaginary line that passes through the center of the cross-section of the arch wire and not around points that are spaced from or away from the center. The results are symmetrical torque bends which avoid causing other movements of the teeth when the wire is in use.

The pliers have two handles pivotally associated by a core, the core having a slot therein. One of the handles has a bifurcated head with the other handle having a single head adapted to fit within said bifurcated head and pivot on the core. The bifurcated headed handle has at least one slide reciprocally associated with a side of the bifurcated headed handle, the slide having a slot in an end thereof, wherein the slide can be manipulated so that its slot is in aligned association with the slot in the core. The core is detachably secured to the single headed handle. Slots are in the single and bifurcated headed handles to access their bores so that all the slots can be aligned to accept an arch wire being passed through the slots in the handles and into the slots of the core and slide. Squeezing of the handles causes relative rotation between the core and slide to impart a twist to the wire. The degree of twist can be adjustably controlled. Preferably, there are two slides, one in each side of the bifurcated headed handle.

The parts are easily assembled and disassembled.

More particularly, there is provided in one aspect orthodontic torque pliers for twists in orthodontic arch wire, comprising a first handle having a single headed portion with a bore therethrough and a rectangular slot. A second handle has a bifurcated headed portion, each bifurcation having a bore therethrough accessed by a slot, the bifurcated headed portion adapted to accommodate the single headed portion wherein the bores of both handles are in alignment and the slots of the bifurcated head are in axial alignment with the slot of the single headed portion. A core is provided for insertion within the bores of the single headed portion of the first handle and bores of the bifurcated headed portion of the second handle means and the core also acts as a pivot for the handles. The core has a rectangular slot therein adapted to accept a portion of the arch wire. The second handle has at least one slide means operatively associated with a side of the second handle wherein the slide means can be manipulated from a retracted position to an extended position. The slide means has a rectangular slot therein and in the extended position, the slot of the slide means in alignment with the core slots and the slots of the single and bifurcated headed portions of the handles. The slide slot is adapted to accept a portion of the arch wire. Squeezing the handles together about the core acting as a pivot causes the core slot and the slide slots to rotate relatively to each other to impart a twist to the arch wire.

The invention also comprehends a method of creating a torque twist in orthodontic arch wire, comprising providing torque pliers having a first handle with a single head means having a bore and rectangular slot, and a second handle with a bifurcated head, each bifurcation having a bore and a slot, the handles pivotally connected by core means within the bores of the handle heads, the core means having a rectangular slot adapted to accept the arch wire when aligned with the slots of the handle heads. The second handle further has at least one slide slidingly associated with a side of the second handle, the slide having a rectangular slot in an end thereof and movable from a retracted position to an extended position. The method further comprises aligning the slide slot, the core slot and the handle slots, inserting the arch wire through the slots of the handle heads into both the slide slot and the core slot, squeezing the handles together to rotate the slide slot and core slot relative to each other, to cause torque twist in the arch wire, releasing pressure slightly on the handles and retracting the slide which disengages the arch wire from the slot of the slide, and removing the arch wire from the core slot and through the slots of the handle heads.

Other aspects of the invention will become more apparent from the description of a preferred embodiment in conjunction with the drawings herein.

### BRIEF DESCRIPTION OF THE DRAWINGS

FIG. 1 is a side view of the assembled pliers of the invention;

FIG. 2 is a partial perspective exploded view of a part of the pliers showing the core and one slide.

FIG. 3 comprises FIG. 3a, a side view of the single ended or headed handle, FIG. 3b a front view thereof, and FIG. 3c an opposite side view thereof;

FIG. 4 comprises FIG. 4a, a side view of the double ended or bifurcated headed handle with a scale or ruler and FIG. 4b is a front view thereof;

FIG. 5 comprises FIG. 5a, a side view of the cylindrical core and FIG. 5b is an end view thereof;

FIG. 6 is a side view of the fixation pin;

FIG. 7 comprises FIG. 7a, a side view of a slide and FIG. 7b a front view thereof, both with views including a slide knob;

FIG. 8 is a side view of the adjustment screw;

FIG. 9 comprises FIG. 9a, an end view of a first portion of the fixation lock assembly and FIG. 9b a side view thereof;

FIG. 10 comprises FIGS. 10a, an end view of a second portion of the fixation lock assembly, and 10b a side view thereof;

FIG. 11 is a side view of the opening spring;

FIGS. 12 and 13 are schematic views of the pivot core and slides before and after application of torque; and

FIG. 14 is an end view of the pivot core with arch wire inserted therein.

### DESCRIPTION OF THE PREFERRED EMBODIMENT

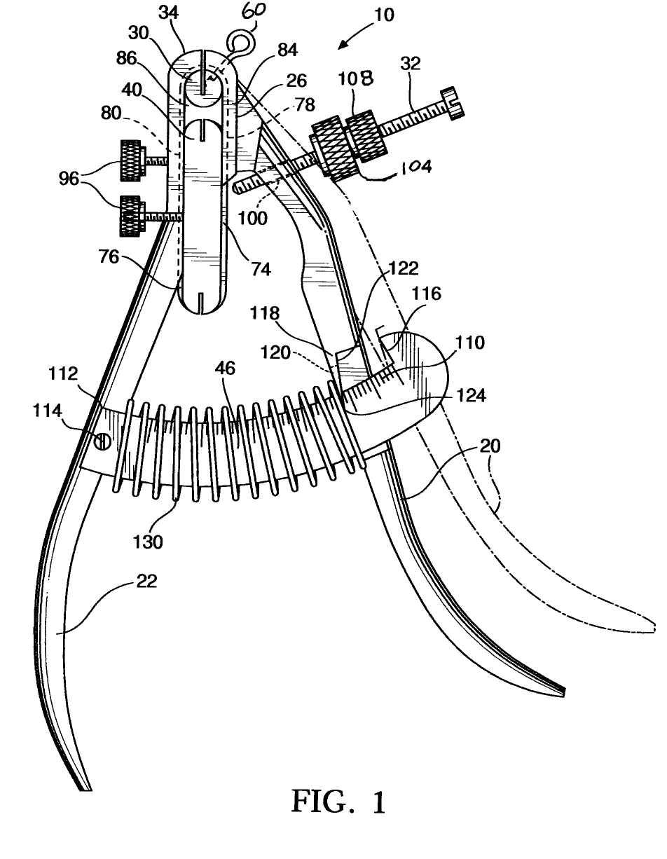

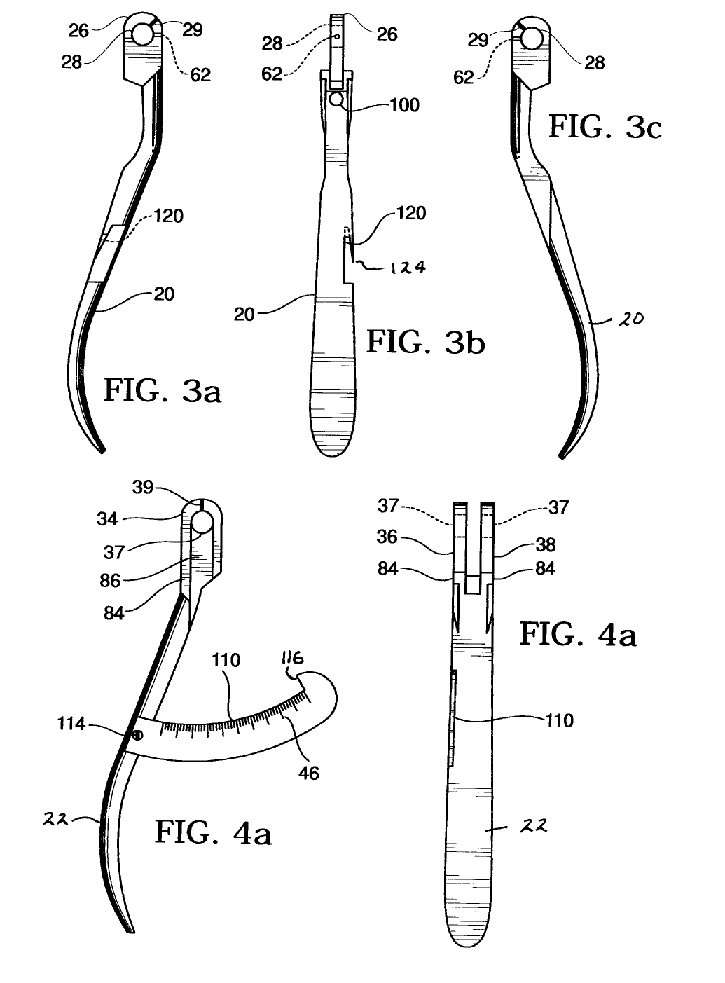

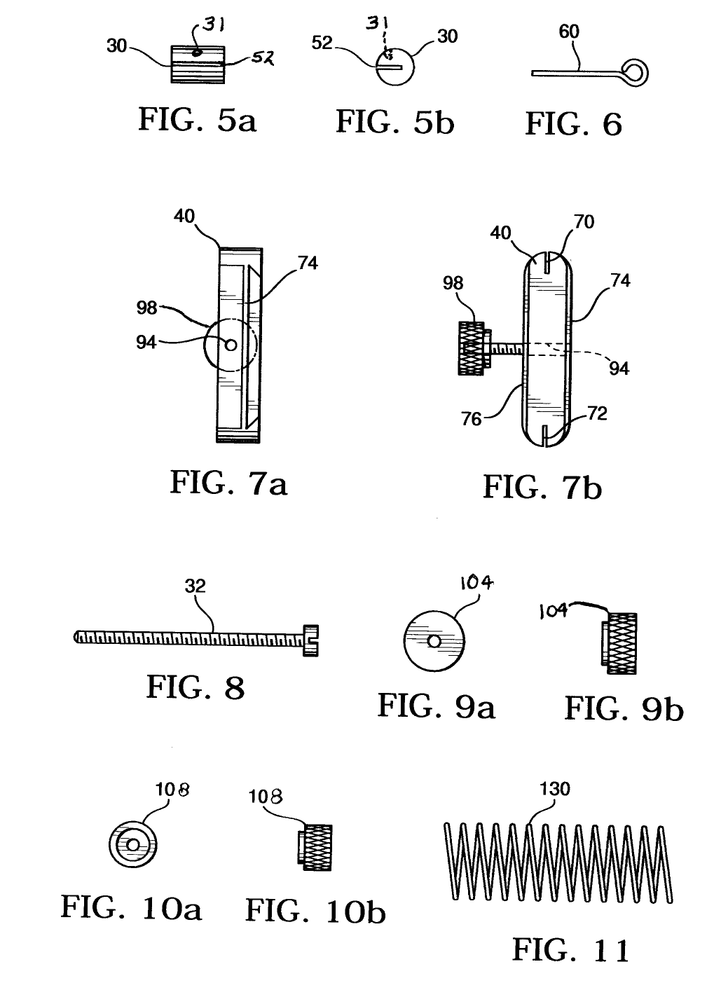

Turning to FIG. 1 which illustrates the pliers or tool 10 assembled and FIGS. 3-11 which illustrate parts of the tool, the tool includes two plier handles 20, 22, which serve as a frame to carry the more active components. One of the plier handles 20 (FIG. 3) is single ended or headed 26 with bore 28 and slot 29. Handle 20 carries core 30 (FIG. 5) as well as the adjustment screw 32 (FIG. 7) in threaded aperture 100 with fixation lock nut assembly 104 and 108 (FIGS. 9 and 10). The other handle 22 (FIG. 4) is double ended or headed 34, having bifurcations 36 and 38. The bifurcated portions 36, 38 each have bore 37 and laterally aligned slots 39. Handle 22 carries two supporting slides 40 (FIG. 7) one on each side of handle 22 and carries a ruler 46.

The core 30 is the element, the articulation or pivot between the handles 20, 22. The diameter of the bores 28, 37 is such that core 30 can be slid axially into the bores. The core 30 is cylindrical with radial slot 52 which is directed inwardly from the peripheral surface of the core to the axial center and past the center by half the depth of the arch wire that will be torqued. The width of the slot is substantially equal to the width of the arch wire to be torqued. The slot 52 in the core 30 is configured such that when the arch wire is at the inner end of the slot 52, the center of the arch wire coincides with the axial center of the core 30. The core is changeable, that is, cores with different sizes of slots are provided to take into consideration arch wires of different cross sectional dimensions.

The core 30 is fixed to the handle 20 by means of a fixation pin 60 (FIG. 6) in friction fit with bore 62 with its end entering recess 31 in pivot core 30. When fixed, the slot 52 of core 30 is aligned with the slots 29 and 39 of handles 20 and 22. The fixation pin secures the core 30 to handle 20, but allows for easy and quick interchangeability of cores within bores 28, 37.

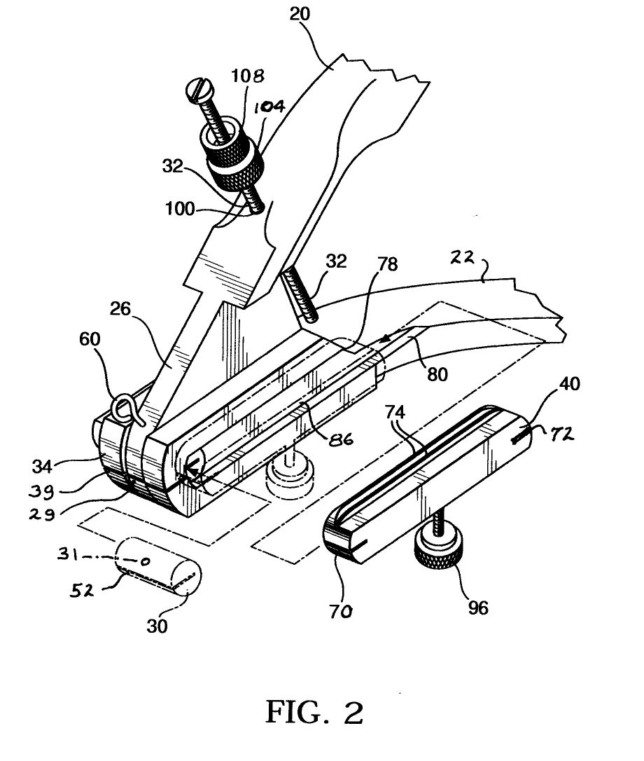

Each support slide 40, there being two, but only one is shown (FIGS. 2 and 7) has slots 70, 72 extending inwardly from opposite ends, the slots 70, 72, the slots of different widths and adaptable to accept arch wire of different cross-sectional size. The slides 40 have ribs 74, 76 which are adapted to slide within grooves 78, 80 in the opposed sides 84 of a recess 86 in handle 22. The slides 40 are held in position in relation to handle 22 so that they can be reciprocated whereby the slot 70 of each slide 40 can be lined up with the slot 52 in the core 30. The slots are equal in depth. If the slides 40 are reversed side to side and end to end, the slot 72 of each slide would line up with the slot 52 with a different core 30. The slides 40 have threaded holes 94 into which threaded knob element 98 can be secured to act as knobs for manipulation of the slides, whereby the Orthodontist's thumb can manipulate and reciprocate one or both slides 40 by the knobs during the process of torque application. The threaded knob element can be rotated so that the bottom thereof contacts the side of the handle and thereby fix the slide in a desired position. The slide slot 70 can be held against the arch wire on at least one side of core 30 during torquing and released from the wire after torquing.

A threaded adjustment screw 32 is fixed to the single headed handle 20 through threaded bore 100 and rotatable threaded lock nut assembly 104, 108 is located on screw 32 and can be adjusted to set a limit to the angle of torque to be applied. In other words the adjustment screw 32 with threaded lock nut assembly 104, 108 sets a reference point or closing limit point between the handles 20, 22 which can be set and it will act as a repeatable point for torque application. This adjustment screw 32 with lock nut assembly 104, 108 can be used to assist the Orthodontist in a single torque exertion when there is a desire to torque an area greater than the width of the core of the pliers. The two points at the beginning and end of the span to be torqued can be made at the same angulation in order to provide symmetrical and a smooth torqued area without distortion. The adjustment screw 32 also provides for a reference point in double torque applications when the Orthodontist wishes to have the exact degree of angulation in identical teeth in opposite halves of an arch wire such as two laterals or two premolars.

The curved ruler 46 is calibrated with scale 110 and is attached at end 112 to the handle 22 by screw 114 (FIG. 1). Ruler 46 also has hook end 116 which is associated with handle 20 at 118 through slot 120. Stop 122 in cooperation with hook end 116 limits the opening of the pliers. The limit of the opening of the pliers is where the slot 52 of core 30 is in line with and in parallel alignment with the slot 70 and/or 72 in the slides 40 and the access slots 29, 39 so that the arch wire can be inserted into the various slots at the opening limit or point of the pliers. The single headed handle 20 has a small pointer 124 which with closure of the pliers can indicate on the scale 110 the degree of torque angle applied to the arch wire.

Finally, spring 130 fits around or encompasses curved ruler 46 (over hook end 116) and maintains the pliers normally in an open position where the core slots 52 and slide slot 70, (72) are aligned as noted previously.

In assembling the pliers, end 112 of curved ruler 46 is attached to handle 22 by screw 114. The small knobs or screws 98 are attached at sides 74 of both slides 40 in threaded association with holes 94. Spring 130 is fitted over hook end 116 and around ruler 46. The hook end 116 of ruler 46 is angled through slot 120 and the two handles 20, 22 and their headed ends 26 and 34 are fitted together so that bores 28 and 37 are aligned. The core 30 can then be axially slid into the bores 28, 37 in the two handles. The core 30 is fixed in place by the fixation pin 60 in friction fit with bore 62 of handle 20 and its end in core recess 31.

The handles 20, 22 are locked together by virtue of the two headed handle 22, with its bifurcations 36 and 38 on either side of single ended portion 26 of handle 20. The core 30 acts as a hinge or pivot for relative rotation between the handles 20, 22. The core hinge is solid and prevents distortion or bending. The adjustment screw 32 with the lock nut assembly 104, 108 thereon is threadably located in position in bore 100 and serves as a reference point to adjust the degree of angle to be applied to the arch wire. Once the adjusting screw 32 is used to adjust the desired angle, it is locked in place by adjusting lock nut assembly 104 and 108 so the position of screw 32 is fixed and the selected torque angle can be repeated and permits for both single and double torque applications as further noted herein. Both slides 40 are slid into position on handle 22 with the knobs 96 extending as shown in FIG. 1 to complete the assembly of the pliers, ready for use. The slide 40 with knob 96 as seen in FIG. 1 is shown with its slotted end spaced from the core 30. Disassembly of the pliers for cleaning or repair is easily accomplished. Also by simply removing the fixation pin, a core with a different sized slot can be easily substituted.

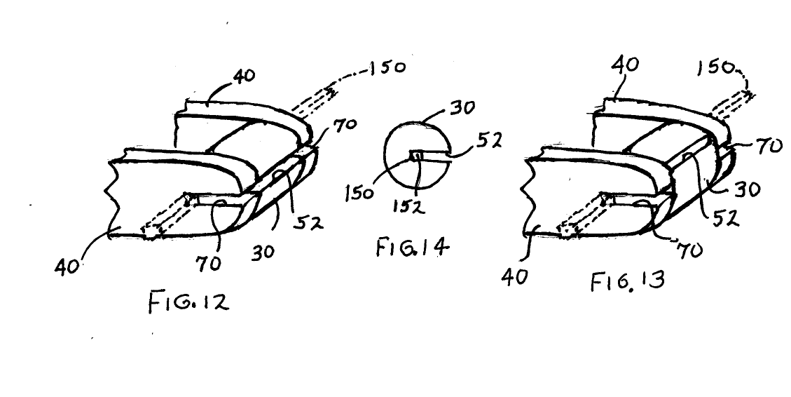

FIGS. 12 and 13 schematically illustrate core 30 and both slides 40 with pivot core slot 52 aligned with slots 70. The headed ends of bifurcated handle 22 and the access slots 29, 39 are not shown. Pivot core 30 is shown in side view in FIG. 14 with rectangular wire 150 therein, it being appreciated that the depth of the slot 52 is configured so that when wire 150 is fully inserted into the slot 52, the axis 152 of the rectangular wire coincides with the axis of pivot core 30. FIG. 13 illustrates the relative position of the pivot core slot 52 and slots 70 of slide 40 after which torque may be applied to the wire by squeezing the handles to pivot the core relative to the slides. After the desired torque has been developed, pressure on the handles is released slightly, but sufficiently to allow the slots of the slide(s) to be retracted from the wire and then the handles are fully released so the slot 52 of the core realigns with the handle access slots 29 and 39 whereupon the wire 150 can be removed.

In operation, the Orthodontist would take the pliers in one hand with the double ended handle 22 having a convex configuration, the convex configuration resting in the palm of the hand with the four fingers of the same hand around the single headed handle 20 which has a concave configuration.

The pliers are capable of exerting torque on arch wire in two modes of operation.

The first mode is the double torque technique (such as shown in FIGS. 12 and 13) in which both slides 40 are in use to support the rectangular arch wire on both sides of the core 30. Both slides 40 are pushed by thumb activity on knob 98 to their extended position and locked wherein the slots 70 are aligned with the slot 52 of core 30 (and access slots 29, 39 of the handles) so the slots form effectively one transverse slot. The access slots 29 and 39 of the handles 20, 22 are also in such alignment and are wider than the slots 52, 70. It will be apparent that the slots 52, 70 must be of the same size or gauge. With the pliers held in one hand, the other hand is used to insert the arch wire through access slots 29, 39 and into the core slot 52 and slide slots 70. Care is taken not to exert any pressure on the plier handles before the wire is completely inserted so as not to lose the opening limit point defined by the ruler hook 116 in cooperation with the stop 122. The rectangular arch wire is supported on both sides of the pliers adjacent slides 40 by the other hand and once the wire is fully inserted into the slots 52 and 70 of the core and slides, the handles 20, 22 are squeezed together until the closing limit point is reached, as determined previously by adjustment of the lock nut assembly 104, 108 and the adjusting screw 32.

Hand pressure is released slightly and the slides 40 are both retracted by the thumbs in cooperation with knobs 96. This releases the strain between the area torqued by the core and area supported by the slides.

After the slides 40 are retracted and the slide slots 70 fully released from the wire, the handles are released further to the limit opening point and the wire pulled from the slot 52 of the core 30 and aligned handle access slots 29, 39. This double torqued area is effectively equal to the width of the core which is confined to a specific single tooth. There is no affect on any other part of the arch wire and the process can be repeated for multiple positions as needed and as a result lead to reduced chair time. The double torque can be repeated effectively on lateral teeth because of the repeatable limiting points provided with the adjustment screw 32 and lock nut assembly 104, 108.

The pliers or tool 10 are also effective to apply a single torque area against a group of teeth. The torqued area is wider than one tooth and may torque an area of two teeth or more, for example. The area desired is marked on the arch wire by the Orthodontist with a marker, both at the beginning and the end of the area. One of the slides 40 is retracted or withdrawn completely from its operative position so that only one slide 40 is extended in operative position where it's slot 70 is aligned with the core slot 52. The wire is manipulated (straightened) by the free hand and inserted through the access slots 29, 39, core slot 52 and single slide slot 70 so that the wire is parallel to the axis of and within the core slot and is transverse to the axis of the slots of the core and the slide in operative use. Once the pliers are squeezed to the desired adjustment limitation point, slight release of the pliers reduces friction between the slide slot 70 and wire and the single slide 40 is retracted, allowing the pliers to then open to the opening limit point and permit withdrawal of the wire from the core slot 52 and access slots 29, 39. There is thus formed a single torque bend to the wire. The wire is then reversed to the opposite side of the marked area and the process repeated.

The torquing of the wire is effective without distortion. The pliers can apply multiple torques, single or double as desired without difficulty, to both the curved portion or straight portion of the arch wire.

Accordingly, with my pliers, torquing arch wires can be performed in one step. There is ease of manipulation and the pliers frees the other hand to hold the arch wire. The degree of torque angle can be repeated easily whether double or single torques is required. Further, the assembly and disassembly of the pliers is provided wherein the core itself acts as the central point for the pliers and can be easily replaced by another core having a different slot gauge.

What is claimed is:

1. Orthodontic torque pliers for imparting torque twists to arch wire, comprising:
first and second handle means and a pivot core, said first and second handles each having a pivot end and a free end, said pivot end of said first and second handles each having pivot bores, said pivot core being detachably fixed within the pivot bore of said first handle and said second handle configured so that the pivot bore of said second handle is pivotally associated with said pivot core whereby the handles can rotate relative to each other about said pivot core;
said pivot core having a slot therein extending inwardly from a peripheral surface to substantially the axial center of said pivot core and said second handle including an access slot, whereby the arch wire can be inserted into said pivot core slot through said access slot when said free ends of said handles are in a first, open position;
a side of said second handle having first means including a slot in fixed alignment with and laterally spaced from said pivot core slot when said handles are in said first position whereby squeezing the free ends of said handles to a selected second position, causes said pivot core slot and said second handle fixedly aligned slot to rotate relative to each other.

2. The orthodontic pliers of claim 1, wherein said means on the side of said second handle is a first slide means slidably and detachably associated with the side of said second handle.

3. The orthodontic pliers of claim 2 wherein said second handle has a second slide means substantially the same as the first slide means, the second slide means being slidably and detachably associated with the other side of said second handle.

4. The orthodontic pliers of claim 1 further comprising spring means associated with said handles to return said handles to the first position once released from said second position.

5. The orthodontic pliers of claim 1 further comprising a calibrated ruler means attached to one of said handles and extending to and in cooperation with the other of said handles.

6. The orthodontic pliers of claim 5 wherein said spring means encompasses and is retained on said ruler means.

7. The orthodontic pliers of claim 1 further comprising an adjustable stop means wherein the degree of relative rotation of said handles can be selectively set.

8. The orthodontic pliers of claim 1 further comprising means for detachably retaining said pivot core within said handle pivot ends.

9. The orthodontic pliers of claim 2 wherein said first slide means has a second slot at its opposite end which is of a different width than said slot means.

10. The orthodontic pliers of claim 2 wherein said slide means includes a knob for facilitating manual sliding movement of said slide means from an operative position in said fixed alignment with said pivot core slot to an inoperative position.

11. A method of creating a torque twist in orthodontic wire comprising:
providing first and second handles and a pivot core;
said first and second handles each having pivot ends and free ends;
said pivot ends of said first and second handles each having bores configured to accept said pivot core and to pivot relative to each other about said pivot core, said pivot core having a slot extending inwardly from a periphery of the pivot core to slightly beyond the axial center of said pivot core, and said pivot ends of said first and second handles having access slots in alignment with said pivot core slot when said handles are in a first position, said pivot core being detachably fixed to said first handle, said second handle having further slot means slidably associated with said second handle from an operative position to a retracted position;
aligning said further slot means in said operative position with said core slot and said access slots of said handles;
inserting the arch wire through the access slots of the handle pivot ends into both said further slot means and said core slot;
squeezing said handle means together to rotate the further slot means and said pivot core slot relative to each other, to cause torque twist in the arch wire;
releasing pressure slightly on said handles and retracting said further slot means to said retracted position to disengage the arch wire from said further slot means; and
removing said arch wire from the pivot core slot and through the access slots of the pivot ends of said handles.

12. The method of claim 11 wherein said first handle pivot end has a single head having the first handle bore and the slot therein, and the second handle pivot end comprising a bifurcated head, each portion of the bifurcated head having a bore and slot therein, said handles being pivotally connected by said pivot core, said further slot means of said second handle comprising a slide slidingly associated with one side of said second handle means, said slide having the further slot means in an end thereof and movable from the retracted position to an operative position;
wherein said aligning step includes sliding the slide into said operative position.

13. The method of claim 12 wherein said second handle means has a second slotted slide associated with the other side of the second handle means and slidable from an operative position to a retracted position, said method further comprising aligning said slots of both said slides in operative position with said access slots and pivot core slot prior to inserting the arch wire.
